(19) United States
(12) Patent Application Publication
(10) Pub. No.: US 2011/0141684 A1
(43) Pub. Date: Jun. 16, 2011

(54) SYSTEMS AND METHODS FOR COOLING A BLADE SERVER INCLUDING A DISK COOLING ZONE

(75) Inventor: Keith Klarer, Carlsbad, CA (US)

(73) Assignee: ASTUTE NETWORKS, INC., San Diego, CA (US)

(21) Appl. No.: 12/816,341

(22) Filed: Jun. 15, 2010

Related U.S. Application Data
(60) Provisional application No. 61/187,165, filed on Jun. 15, 2009.

(51) Int. Cl. G06F 1/16; G06F 1/20

(52) U.S. Cl. 361/679.33; 361/679.54; 361/679.52

(57) ABSTRACT

A method and apparatus adapted to cool a blade server positioned within a rack of other blade servers include transferring heat from a heat source in the blade server to a cooling zone positioned at an interface between a top plate of the blade server and a heat transferring element within the blade server that transfers the heat to a cooling medium. The method and apparatus use an active cooling device that is selectively activated to pump heat from the cooling zone to a heat exchanger positioned away from the heat source when temperatures of the heat source reach predefined levels.

### CROSS-REFERENCE TO RELATED APPLICATIONS

This application claims priority under 35 U.S.C. §119(e) to U.S. Provisional Patent Application Ser. No. 61/187,165, entitled SYSTEM AND METHOD FOR COOLING A BLADE SERVER INCLUDING A DISK COOLING ZONE, filed on Jun. 15, 2009, the content of which is incorporated by reference herein in its entirety for all purposes.

### FIELD OF THE INVENTION

The invention relates to cooling of electronics in an enclosure and, more particularly, to systems and methods for cooling one or more components configured within a blade server, including one or more disk drives.

### BACKGROUND

A blade server is a single circuit board populated with components, such as processors, memory, disk drives and network connections, designed to slide into an enclosure that typically houses multiple blade servers. These enclosures are often referred to as “bladed computing systems.”

Bladed computing systems have been adopted into many environments because of a number of distinct advantages over other computing form factors. One principal advantage is computing density: the amount of computing operations per cubic inch of space is higher for blades than for most other technologies. End users leverage this advantage in order to service space-constrained environments, or to reduce operating costs that are driven by space usage.

Attention is directed to FIG. 1, which shows a blade element (“blade”) 110 (e.g., a blade server) and a bladed computing system 120 from which the blade 110 has been removed. The blade 110 commonly performs computing, networking, storage, signal processing or other type of operations. The bladed computing system 120 can hold any number of blades (e.g., typically up to sixteen blades), which are vertically oriented in the bladed computing system 120. The extracted blade 110 is configured to slide into the fifth slot of the bladed computing system 120, as numbered from left to right. A latching mechanism holds the blade 110 in the bladed computing system 120 during normal operation.

Attention is now directed to FIG. 2, which depicts a frame 230 that holds three bladed computing systems 220a-c, each of which enclose sixteen blades. As shown, the frame 230 allows for the insertion of multiple bladed computing systems 220a-c, which provides for a large number of blades per square area of floor space when compared to a single enclosure (e.g., a bladed computing system 120 of FIG. 1). The higher the number of blades per square area of floor space translates into greater computing density per square area of floor space, which increases the computing output of a computing environment.

The increased computing density comes with design challenges. As dictated by the laws of thermodynamics, the more computing that is done in a finite volume, the higher the amount of heat generated in that volume. In bladed computing systems, a large fraction of the volume in a blade is occupied by active components, and the resulting heat density is very high. This problem is compounded by the fact that blades have a very narrow profile relative to their volume, which increases the difficulty in transporting a cooling medium (e.g., air, liquid) through the blade. Considerable care must be applied to design systems and methods that can effectively remove heat from the blades, otherwise the blade components will be damaged by excessive temperatures.

Attention is now directed to FIG. 3, which illustrates one particular method for cooling a blade 310, which has been inserted into a bladed computing system 320. As shown in FIG. 3, cool air enters the lower portion of the bladed computing system 320 and passes through the blade 310 (from bottom to top). The air temperature rises as it extracts heat from components in the blade 310. The hot air exits the top of the blade 310 and is vented outside of the bladed computing system 320. One or more mechanical fans 340 control the air flow. As shown, the fans 340 are positioned at the air entry point and air exit point of the bladed computing system 320, but can be positioned elsewhere to enhance air flow.

Each component in a blade has a maximum operating temperature. The amount of heat each component produces and the spatial organization of the components all determine the type of cooling apparatus needed in a blade. For example, disk drives present a special challenge because their maximum operating temperature is typically much lower than that of any other components used in bladed systems. Most computing elements in a blade can work continuously with an internal temperature of 90° C., while a typical disk can only tolerate a sustained internal temperature of 50° C. Disks also have an absolute maximum operating temperature of 60° C., while other components can withstand temporary excursions to 100° C. or higher.

Current blade server designers face many design challenges. One of the key challenges is minimizing overall design costs. Another is keeping blade server electronic components cool and within their operating specifications. A successful blade server design must address these critical issues—that is, heat and cost.

### SUMMARY

In summary, the present invention is directed to systems and methods for cooling a heat source in a blade server. In this regard the method entails transferring heat from the heat source to a cooling zone positioned where a heat conduit may be in thermal contact with a top plate of the blade server. The heat conduit comprises any number of heat exchanging components, including at least an active cooling device such as a thermoelectric cooler. In addition, the thermoelectric cooler may be selectively activated when temperature at or around the heat source exceeds a predefined threshold, thereby cooling the heat source.

In another aspect, the present invention relates to an apparatus configured to cool a heat source in a blade server. The apparatus comprises a top plate adapted to transfer heat from the heat source to a heat conduit, which comprises any number of heat exchanging components, including an active cooling device such as a thermoelectric cooler. The apparatus further includes a sensing element adapted to monitor temperature at or around the heat source, and a switching element adapted to activate the thermoelectric cooler when the sensing element determines that the temperature at or around the heat source exceeds a predefined threshold.

Embodiment details and some alternatives are set forth in the accompanying drawings and the description below. Because all embodiments of the invention cannot reasonably be described herein, the described embodiments must be understood as illustrating, rather than limiting, the invention. Additional details of aspects of the present invention are further described below in conjunction with the appended drawings.

### BRIEF DESCRIPTION OF THE DRAWINGS

For a better understanding of the nature of the features of the invention, reference should be made to the following detailed description taken in conjunction with the accompanying drawings, in which:

FIG. 1 shows a blade and a bladed computing system from which the blade has been removed;

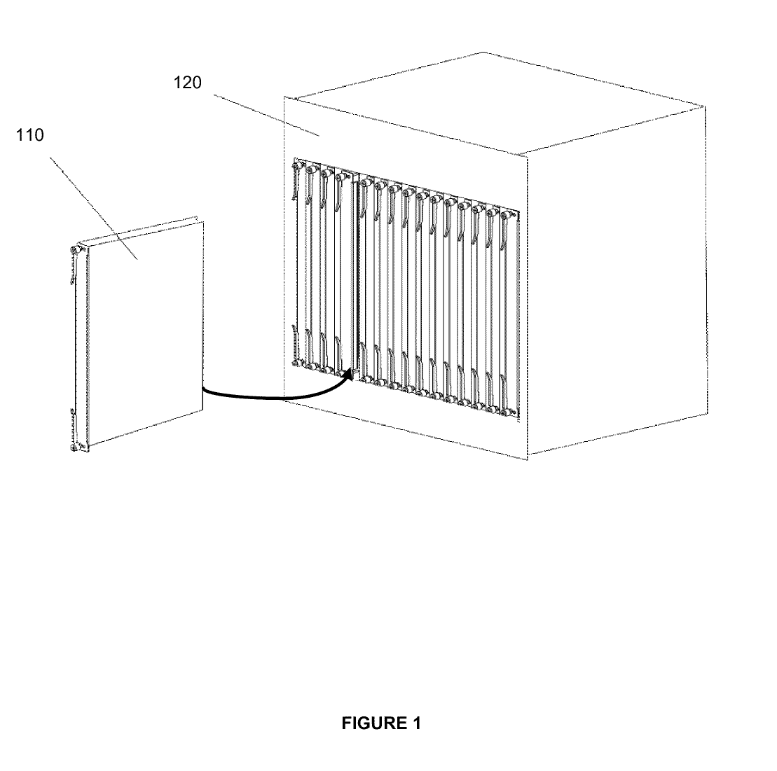

FIG. 2 depicts a frame that holds three enclosures, each of which enclose sixteen blades;

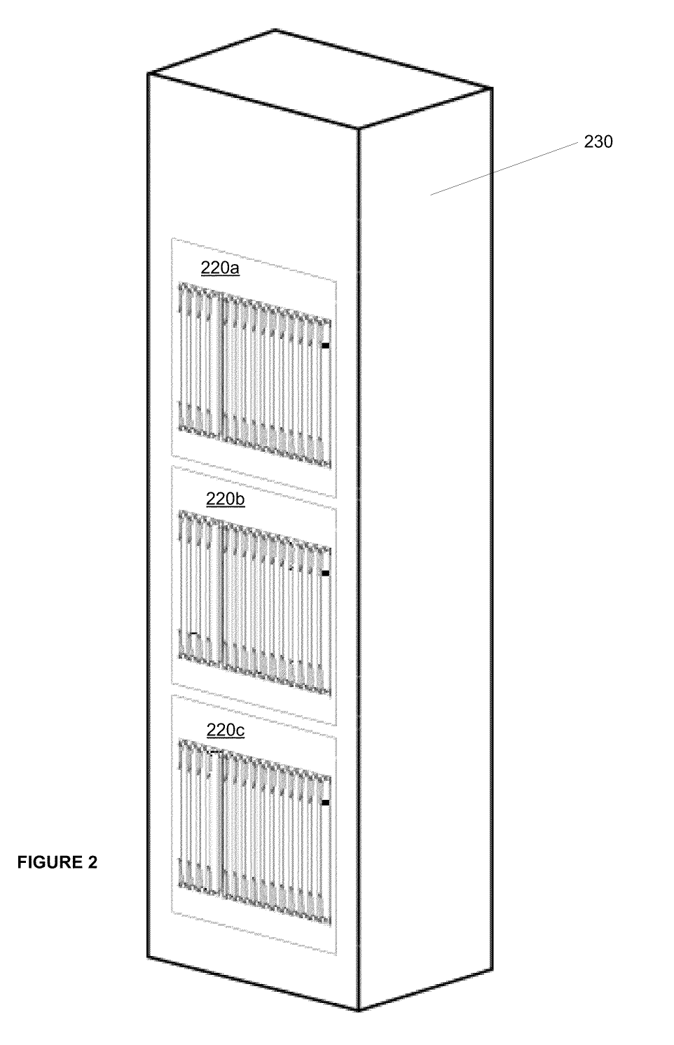

FIG. 3 illustrates a system and method for cooling a blade;

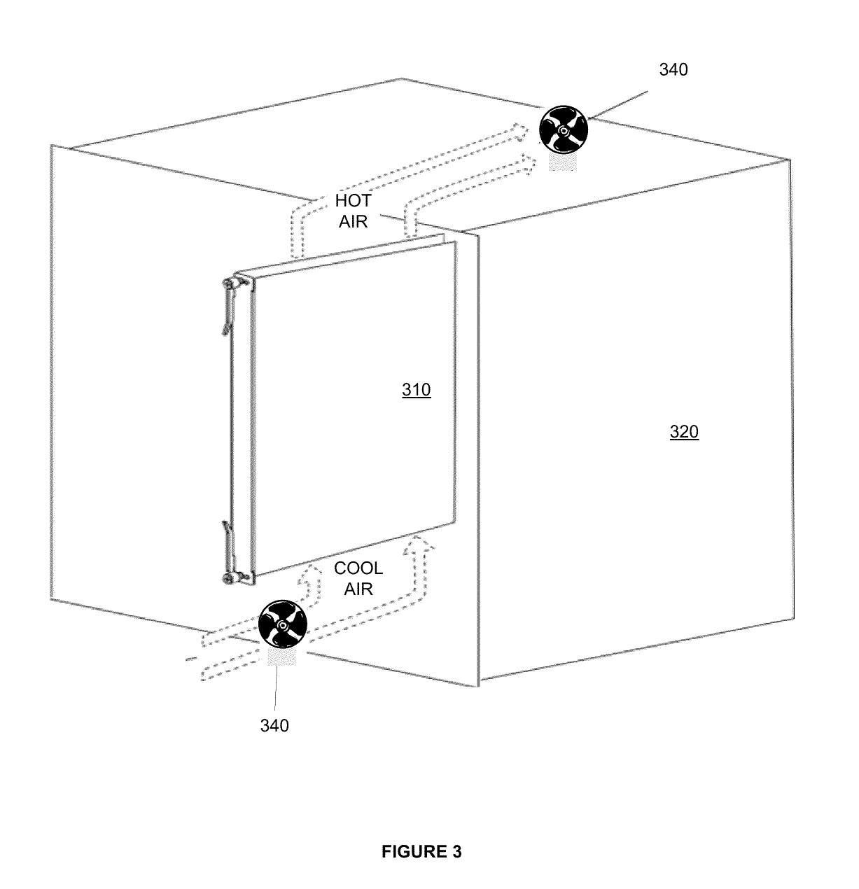

FIG. 4 depicts a side-view block diagram of certain elements configured within a blade;

FIG. 5 illustrates a top-view block diagram of certain elements configured within a blade;

FIG. 6 depicts an isometric view of certain elements configured with a blade; and

FIG. 7 depicts an isometric view of the elements depicted in FIG. 6 in addition to other elements not depicted in FIG. 6.

### DETAILED DESCRIPTION OF EMBODIMENTS

The present invention is directed generally to systems and methods for cooling blade computing components such as blade servers (also denoted herein as blade elements or “blades” for brevity).

In general, the invention relates to systems and methods for cooling disk drives in blade servers; however, cooling of other blade computing components that generate heat is also contemplated within the spirit and scope of the invention.

In one aspect, the present invention relates to a method for cooling a heat source of a blade element, comprising transferring heat from a first region of the blade element including the heat source to a cooling zone positioned proximate to a heat conduit in thermal contact with the blade element and selectively engaging the heat conduit to transfer heat from the cooling zone to a second region of the blade element. The heat source may be one or more electronic devices, which may be disk drives or other heat-generating electronic devices such as processors. The heat conduit may be a thermoelectric cooler, a heat pipe, or another type of heat conduit. The cooling zone may be positioned where a top plate of the blade element interfaces with a portion of the heat conduit. A sensing element may be used to monitor ambient temperature at or around the heat source, which may be within a predetermined distance to the heat source representative of local heating and associated temperature at the heat source. The sensing element may be coupled to a control apparatus so as to engage the heat conduit when the ambient temperature reaches a predefined level, thereby cooling the heat source.

In another aspect, the invention relates to an apparatus for cooling a heat source of a blade element, comprising a cooling zone adapted to transfer heat from the heat source to a heat conduit, a sensing element adapted to monitor temperature at or around the heat source and a switching element adapted to selectively engage the heat conduit when the sensing element determines that the temperature at or around the heat source exceeds a predefined threshold.

The heat source may comprise one or more electronic devices, which may be disk drives or other heat-generating electronic devices such as processor. The heat conduit may be a thermoelectric cooler, a heat pipe, or another type of heat conduit. The cooling zone may be positioned where a top plate of the blade element interfaces with a portion of the heat conduit. A sensing element may be used to monitor ambient temperature at or around the heat source, which may be within a predetermined distance to the heat source representative of local heating and associated temperature at the heat source. The sensing element may be coupled to a control apparatus so as to engage the heat conduit when the ambient temperature reaches a predefined level, thereby cooling the heat source.

In another aspect, the present invention relates to a blade server comprising a top plate, one or more electronic devices, a heat conduit positioned so as to interface with a portion of the top plate, a cooling zone adapted to transfer heat from the one or more electronic devices to a heat conduit, said cooling zone positioned where the top plate interfaces with a portion of the heat conduit, a sensing element adapted to monitor temperature at or around the one or more electronic devices and a switching element configured to selectively engage the heat conduit when the sensing element determines that the temperature at or around the one or more electronic devices exceeds a predefined threshold. The one or more electronic devices may comprise disk drives or other heat generating electronic devices such as a processor. The heat conduit may comprise a thermoelectric cooler, a heat pipe or other or another type of heat conduit.

In another aspect, the present invention relates to computer-implemented methods for controlling heating in a blade. The computer-implemented method may include receiving, from a temperate sensor, heating information associated with heating within an area of the blade, such as at or near a heat source, and selectively controlling, responsive to receipt of the heating information, a heat conduit to cool the heat source. The computer-implemented method may be embodied in a tangible medium as instructions, such as instructions for causing a processor to implement the methods as described herein. The instructions may be stored on a medium such as in a physical memory device, a disk drive, a data storage medium such as a DVD disk, Blu-Ray disc or other data storage disk or device. The processor may be an integral processor component of the blade or may be a dedicated processor for managing heating and cooling.

In various embodiments, the above-described elements and functions may be combined with other elements or functions as are described herein to provide various advantages and/or solve various problems. For example, there are at least two significant problems that may be addressed by embodiments of the invention. The first problem relates to the inability of passive heat movement alone to maintain a desired range of temperatures for temperature-sensitive components in a blade server (e.g., a disk drive or other heat generating component). The second problem pertains to the impeded flow of a cooling medium (e.g., air) through a blade. Due to the compact configuration of components in a blade, existing approaches and apparatus for circulating a cooling medium do not permit it to effectively reach all heated surface areas enclosed in the blade.

Several aspects of the invention, either alone or in combination, overcome the aforementioned problems, as well as others. One aspect of the invention provides a cooling zone that conducts heat away from one or more disk drives in a blade server. Another aspect of the invention relates to an active cooling element (e.g., a thermoelectric cooler) that draws heat away from the one or more disk drives (e.g., via the cooling zone) and transfers the heat to a heat exchanger. Yet another aspect of the invention provides a selective cooling arrangement in which a heat sensor or the like monitors the heat at the disk drive and signals the active cooling element to turn on or off depending on the temperature at the disk drive.

As described herein, blades perform various operations, including computer, networking, storage, signal processing and other types of operations. The embodiments described herein are not intended to limit the invention. One of skill in the art will appreciate alternatives to the embodiments described herein within the spirit and scope of the invention.

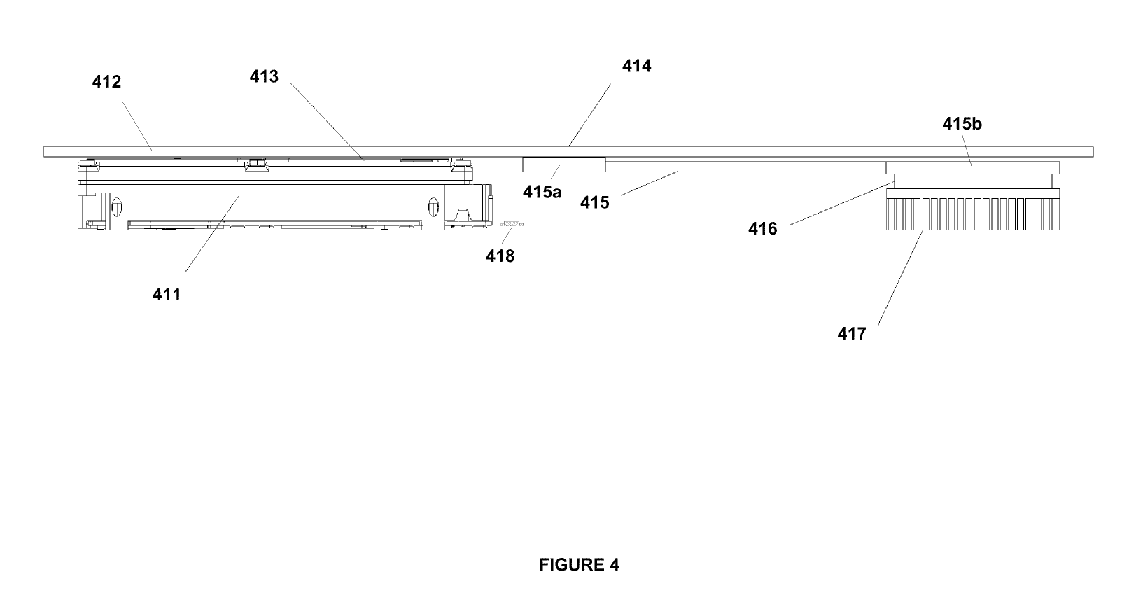

Attention is now directed to FIG. 4, which depicts a block diagram of certain components of a blade 410 from the perspective of a side view. As shown, the blade 410 may include one or more disk drives 411, a top plate 412, interface material 413 between the disk drive 411 and the top plate 412, a cooling zone 414, a heat pipe 415, a thermoelectric cooler 416, a heat exchanger 417 (e.g., a heatsink), and a temperature sensor 418.

The disk drives 411 may include any conventional disk drives that create heat during operation and/or are sensitive to ambient heat in the blade 410 (e.g., heat from other components or the computing system environment). The interface material 413 conducts heat from the disk drive 411 to the top plate 412. It may also provide mechanical compliance to allow for variations in disk drive height, while maintaining a high thermal conductivity. The interface material 413 may be composed of a highly conformal, thermally conductive gap filling material, including Bergquist GP1500R and Chomerics THERM-A-GAP F574. The top plate 412 may be formed from any number of heat transferring materials that are capable of collecting heat from the disk drives 411 (e.g., via the interface material 413) and transporting that heat to the heat pipe 415 (e.g., via the cooling zone 414). For example, the top plate 412 may be formed of aluminum, copper or both aluminum and copper, as well as other heat conductive materials. The area of the top plate 412 that can effectively transfer heat from the disk drive 411 to the heat pipe 415 is the cooling zone 414. The cooling zone 414 may be formed of any of the same materials that can form the top plate 412, including aluminum and copper, and/or other materials. The heat pipe 415 provides a very low thermal impedance path from the top plate 412 to the thermoelectric cooler 416. In one embodiment, the heat pipe 415 contains water as the heat transfer medium between the two ends of the heat pipe 415. The thermoelectric cooler 416 pumps heat out of the heat pipe 415 and into the heat exchanger 417. The heat exchanger 417 may be located in an area at the rear of the blade that has a relatively large contact area with a cooling medium (e.g., air).

The heat pipe 415 preferably includes a sealed aluminum or cooper container whose inner surfaces have a capillary wicking material. A heat pipe is similar to a thermosyphon. However, heat pipes differ from a thermosyphons by virtue of their ability to transport heat against the gravitational forces present in an evaporation-condensation cycle with the help of porous capillaries that form a wick. The wick provides the capillary driving force to return the condensate to the evaporator. The quality and type of wick usually determines the performance of the heat pipe. Different types of wicks are used depending on the application for which the heat pipe 415 is being used.

As previously mentioned, one important aspect of the invention relates to an active cooling element that removes heat from a cooling zone. In accordance with one embodiment, a Peltier effect thermoelectric cooler (e.g., the thermoelectric cooler 416) is configured to pump heat from the cooling zone 414 to the heat exchanger 417. The thermoelectric cooler 416 can move significantly more heat than could be removed using passive heat conduction materials, which results in commensurately lower disk temperatures. Thermoelectric cooling technology that may be used in the present invention is described in, for example, Thermoelectrics Handbook: Macro to Nano by D. M. Rowe (Dec. 9, 2005, UK CRC Press). One on skill in the art will appreciate alternative technology to that described in the Thermoelectrics Handbook that can be used in the present invention.

The heat pipe 415 may be configured to transfer the heat from the cooling zone 414 to the thermoelectric cooler 416, which may then efficiently move the heat to the heat exchanger 417, which may reside in an area of the blade where a cooling medium (e.g., air) can effectively move the heat from the blade. As heat is removed from the end 415b of the heat pipe 415 that interfaces with the thermoelectric cooler 416, a virtually identical amount of heat may be transported to the end 415a of the heat pipe 415 that interfaces with the top plate 412. Accordingly, the heat pipe 415 and thermoelectric cooler 416 form a heat conduit between the cooling zone 414 and the cooling medium.

One of skill in the art will appreciate alternative embodiments that include different configurations than that shown in FIG. 4, but also serve to actively transport heat from the disk drive 411 to the heat exchanger 417 in order to cool the disk drive 411. For example, alternative configurations may include a thermoelectric cooler 416 positioned at the cooling zone 414 so as to create a thermal connection between the thermoelectric cooler 416 and the top plate 412. This may render the heat pipe 415 unnecessary, or it may be positioned to deliver heat from the thermoelectric cooler 416 to the heat exchanger 417. Alternatively, the thermoelectric cooler 416 may be positioned between the disk drive 411 and the top plate 412.

In accordance with one embodiment of the invention, the mechanical dimensions and operating characteristics of the thermoelectric cooler 416 are tuned to match computing system requirements (e.g., the size of the blade 410, the heat generation of the various components in the blade 410, the position of other components in the blade 410 (not shown), etc.). The thermoelectric cooler 416 may be positioned so that one of its surfaces interfaces with a surface of the heat exchanger 417. The thermoelectric cooler 416 may be further positioned so that another of its surfaces interfaces with a surface of the heap pipe 415. The interface surfaces of the thermoelectric cooler 416 may be dimensioned so as to closely match the dimensions of the respective interface surfaces of the heat pipe 415 and the heat exchanger 417 in order to maximize the contact area between the components and thus minimize the thermal resistance between the components.

In further accord with the embodiment described in the preceding paragraph, the thickness of the thermoelectric cooler 416 may be based upon many factors, including the internal composition of the thermoelectric cooler 416, the amount of energy that is applied to the thermoelectric cooler 416 in order to effectively move heat away from the disk drives 411 within a designated period of time, and the volume of space occupied by the thermoelectric cooler 416. Once calculated, the dimension requirements regarding the thickness of the thermoelectric cooler 416 can be calculated. For example the following formula may be used to determine the thickness dimensions of the thermoelectric cooler 416:

$${T}_{1} = \frac{( - P * {I}_{tec} + {I}_{tec}^{2} * \frac{{R}_{p}}{2} + {Q}_{1} )}{( {C}_{1} + {C}_{p} )} + \frac{( {Q}_{1} + {I}_{tec}^{2} * {R}_{p} )}{( {C}_{h} + {T}_{3} )} ,$$

where:
P=Peltier constant, (Qₘₐₓ+Iₘₐₓ²*Rₚ/2)/Iₘₐₓ;
Qₘₐₓ=maximum heat transferable by the thermoelectric cooler (TEC);
Rₚ=TEC resistance, Vₘₐₓ/Iₘₐₓ;
I_{tec}=TEC drive current;
Q₁=heat produced by thermal load (Watts);
C₁=thermal conductivity (Watts/° C.) of thermal load to ambient;
Cₚ=TEC thermal conductivity, Qₘₐₓ/ΔTₘₐₓ;
Cₕ=heatsink thermal conductivity to ambient air;
T₁=load temperature; and
T₃=ambient temperature.
   During the thermoelectric cooler design analysis process, each of the variables in the equation above may be adjusted to meet the design requirements. P, the Peltier constant, may be assigned a value as the other values are fixed. Once this value is known, it may be compared against measured values of P versus thermoelectric cooler thickness (given constrained length and width dimensions) in order to determine the required thickness for the thermoelectric cooler 416.

As an active cooling element, the thermoelectric cooler 416 consumes electrical power during its operation. In one embodiment, the thermoelectric cooler 416 is selectively activated during the times when the ambient temperature at or around the disk drive 411 reaches a predefined temperature level (e.g., the maximum operational temperature of the disk drive 411). This selective activation aspect of the invention may function to reduce the overall power consumption of the thermoelectric cooler 416. Under circumstances where the ambient temperature of the blade environment is low enough that the disk drive 411 remains below its maximum operating temperature without active cooling, power may not be applied to the thermoelectric cooler 416. In this case, power savings, may be realized when ambient temperature is low.

An electronics temperature sensor 418 may be positioned near the disk drive 411 to monitor the ambient temperature. When the sensor determines that a predefined temperature level has been reached, an electronic switch (not shown in FIG. 4) may activate the thermoelectric cooler 416. A high precision integrated digital thermometer, such as a Dallas Semiconductor DS1631, can be used as the sensor 418. The electronic switch may be implemented as a combination of digital logic and a field effect transistor which gates the power to the thermoelectric cooler. The digital logic reads the sensor value and compares it to the predefined temperature level. If the predefined temperature level is reached, it may activate the field effect transistor, which may then switch on and provide power to the thermoelectric cooler. A field effect transistor such as an International Rectifier IRF6622 has the appropriate electrical characteristics to switch power to the thermoelectric cooler in some embodiments. However, one of skill in the art will appreciate alternative components to those described above while keeping within the scope and spirit of the invention.

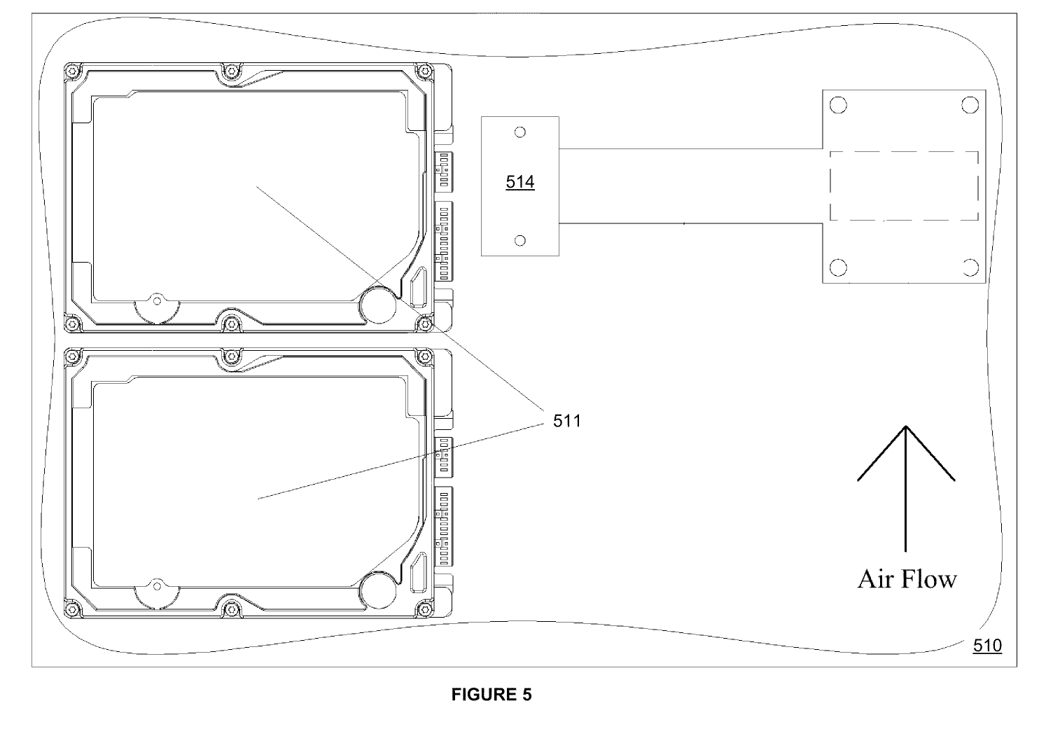

Attention is now directed to FIG. 5, which illustrates a top view of certain elements configured within a blade 510. As shown, the blade 510 may include multiple disk drives 511 and a cooling zone 514 that may be positioned near the upper-most disk drive 511. As shown, air flows from the bottom to the top of the vertically-mounted blade 510. Similarly, heat rises within the blade 510, which makes cooling the top of the blade 510 more critical than cooling lower areas of the blade 510. The placement of the cooling zone 514 near the top of the vertically-mounted blade 510 enables more-effective heat transfer from the disk drives 511 in relation to alternative placements of the cooling zone 514. However, one of skill in the art will appreciate alternative positions and sizes in relation to the cooling zone 514 that are within the spirit and scope of the invention. For example, the blade 510 may include multiple cooling zones 514 near each of the disk drives 511. These cooling zones 514 may have their own heat conduits (not identified in FIG. 5) or may be connected to a single heat conduit.

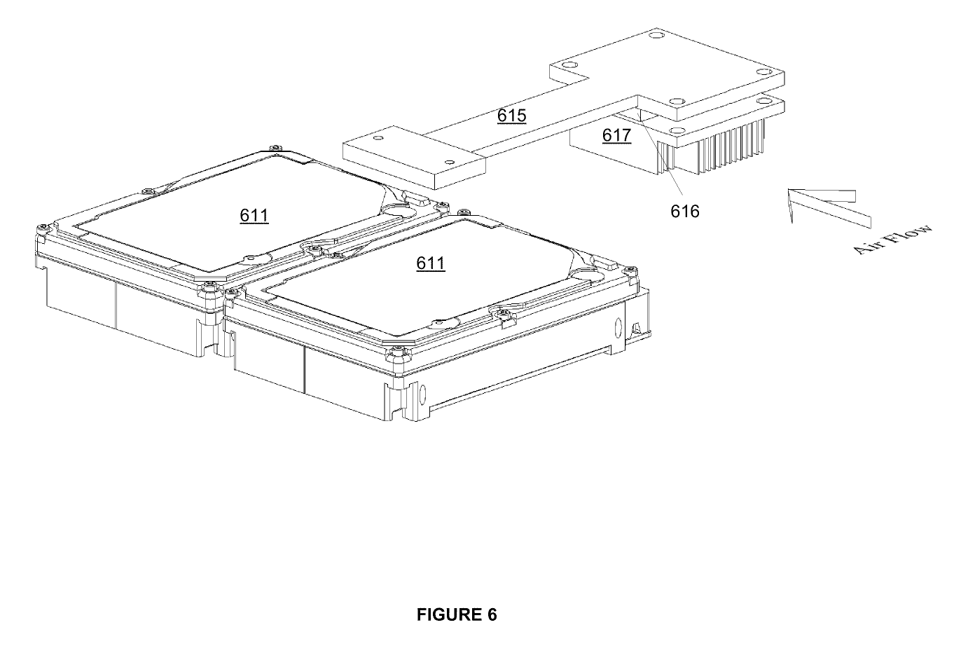

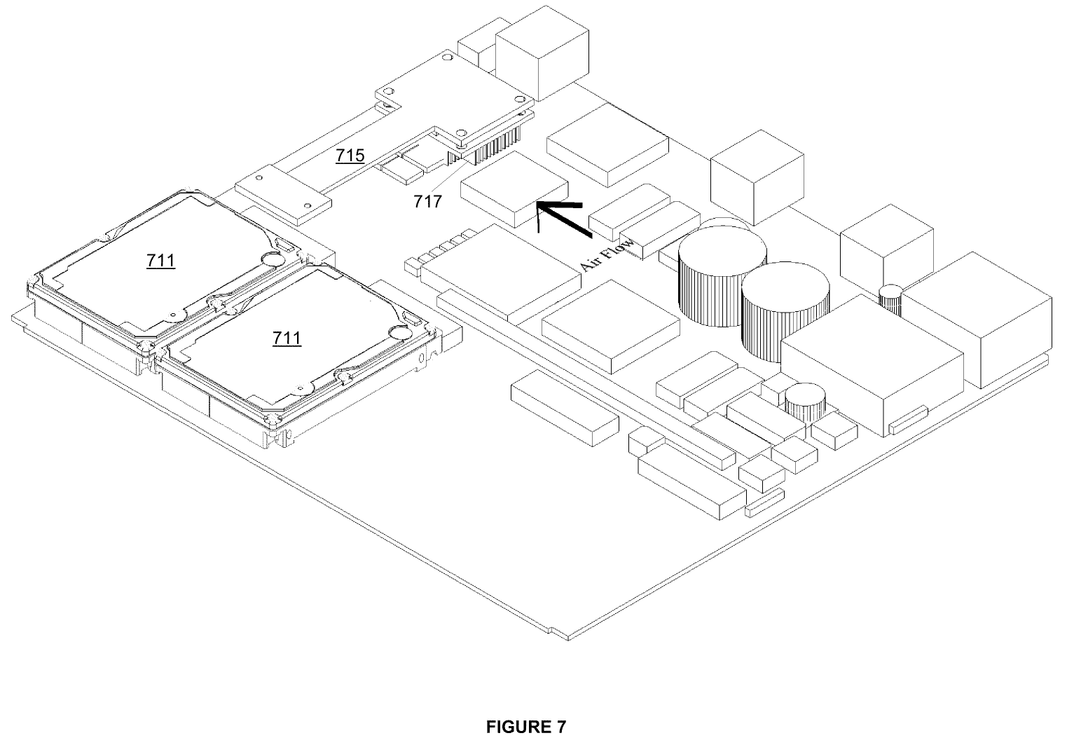

Attention is now drawn to FIGS. 6 and 7, which provide isometric views of certain elements configured within a blade. As shown, the elements include multiple disk drives 611 and 711, heat pipes 615 and 715, a thermoelectric cooler 616 and heat exchangers 617 and 717. FIG. 7 also includes a printed circuit board and electronics from a blade in which the elements operate.

The previous description of the disclosed embodiments is provided to enable a person of ordinary skill in the art to make or use the present disclosure. Various modifications to these embodiments will be readily apparent to those skilled in the art, and the generic principles defined herein may be applied to other embodiments without departing from the spirit or scope of the disclosure. Thus, the present invention is not intended to be limited to the embodiments shown herein but is to be accorded the widest scope consistent with the principles and features disclosed herein. It is intended that the following claims and their equivalents define the scope of the invention.

I claim:

1. A method for cooling a heat source of a blade element, comprising:
transferring heat from a first region of the blade element including the heat source to a cooling zone positioned proximate to a heat conduit in thermal contact with the blade element; and
selectively engaging the heat conduit to transfer heat from the cooling zone to a second region of the blade element.

2. The method of claim 1, wherein the heat source comprises one or more electronic devices.

3. The method of claim 1, wherein the heat source comprises one or more disk drives.

4. The method of claim 1, wherein the heat conduit comprises a thermoelectric cooler.

5. The method of claim 1, wherein the heat conduit comprises a heat pipe.

6. The method of claim 1, wherein the cooling zone is positioned where a top plate of the blade element interfaces with a portion of the heat conduit.

7. The method of claim 1, wherein a sensing element monitors ambient temperature at or around the heat source.

8. The method of claim 7, wherein the sensing element selectively engages the heat conduit when the ambient temperature reaches a predefined level, thereby cooling the heat source.

9. An apparatus adapted to cool a heat source of a blade element, comprising:
a cooling zone adapted to transfer heat from the heat source to a heat conduit;
a sensing element adapted to monitor temperature at or around the heat source; and
a switching element adapted to selectively engage the heat conduit when the sensing element determines that the temperature at or around the heat source exceeds a predefined threshold.

10. The apparatus of claim 9, wherein the heat source comprises one or more electronic devices.

11. The apparatus of claim 9, wherein the heat source comprises one or more disk drives.

12. The apparatus of claim 9, wherein the heat conduit comprises a thermoelectric cooler.

13. The apparatus of claim 9, wherein the heat conduit comprises a heat pipe.

14. The apparatus of claim 9, wherein the cooling zone is positioned where a top plate of the blade element interfaces with a portion of the heat conduit.

15. A blade server, comprising;
a top plate;
one or more electronic devices;
a heat conduit positioned so as to interface with a portion of the top plate;
a cooling zone adapted to transfer heat from the one or more electronic devices to a heat conduit, said cooling zone positioned where the top plate interfaces with a portion of the heat conduit;
a sensing element adapted to monitor temperature at or around the one or more electronic devices; and
a switching element configured to selectively engage the heat conduit when the sensing element determines that the temperature at or around the one or more electronic devices exceeds a predefined threshold.

16. The server of claim 15 wherein the one or more electronic devices comprises one or more disk drives.

17. The server of claim 15, wherein the heat conduit comprises a thermoelectric cooler.

18. The server of claim 15, wherein the heat conduit comprises a heat pipe.
